(19) United States
(12) Patent Application Publication
(10) Pub. No.: US 2023/0071746 A1
(43) Pub. Date: Mar. 9, 2023

(54) METHOD FOR CLOUD COMPUTING COST REIMBURSEMENT PAYMENT

(71) Applicant: Megabit, LLC, Hockessin, DE (US)

(72) Inventor: James D. Joyner, St. Louis, MO (US)

(73) Assignee: Megabit, LLC, Hockessin, DE (US)

(21) Appl. No.: 17/901,757

(22) Filed: Sep. 1, 2022

Related U.S. Application Data
(60) Provisional application No. 63/239,766, filed on Sep. 1, 2021.

(51) Int. Cl. G06Q 20/40; G06Q 20/24; G06Q 20/26; G06Q 20/10; G06Q 20/02; G06Q 20/32

(52) U.S. Cl. CPC G06Q 20/407; G06Q 20/24; G06Q 20/26; G06Q 20/10; G06Q 20/023; G06Q 20/322

(57) ABSTRACT

The method has the collection of data from a user to apply for licensing cost reimbursement for a software application. The method processes payments from the user per service terms. The service terms appear in an electronic agreement displayed to the user and cover the user and the customer of the user utilizing the method. The provider pays the user the amount per the agreement less the license cost, per payment schedule billing, and any other fees. The method provides a platform for the user to provide a service, receive payment for the service, and cover the license cost to the user only upon receipt of payment from the user's customer. The invention does not create an independent contractor and an employee relationship with its user.

### CROSS-REFERENCE TO RELATED APPLICATIONS

This non provisional application claims priority to provisional application Ser. No. 63/239766 filed on Sep. 1, 2021 which have a common inventor.

### BACKGROUND OF THE INVENTION

The present invention relates to a method of cloud computing reimbursement payment.

From the abacus, to punch cards, to mainframes, to the personal computer, and now to smart phones, computers have and continue to run on software. A person who uses a computer is called a user. Even an abacus had a user back in the day. Once again, smart phones have users. Users have familiarity with purchasing and installing software. Not long ago, a user would buy software on various discs and install it himself. And users were happy for years. With the advent of faster internet and greater storage, software companies returned to leasing software to users, that is, licensing. Software companies had done so before with large companies, corporations, and agencies. Such licenses readily exceeded four figure sums. Software companies no longer deliver software on discs to users but rather license access to software stored online. Users from the individual to companies, corporations, and agencies nowadays utilize software located away from them but operable by them for a fee, the license fee.

All good things though have their less glamorous features. Currently, payment for a license to software consumes too much time for a user and other resources for businesses, namely money. Perhaps a business may recoup a portion of the license fee.

### DESCRIPTION OF THE PRIOR ART

Existing software companies provide their applications that collect revenue from when a user of the software application receives a payment from a customer. These existing software applications pay the software application user a percentage of each sale, such as per sale, weekly, bi-weekly, or other frequency. The software application user thus becomes an independent contractor or employee for the software application company. The prior art lacks a signup feature for its customer of cloud-based software to seek cost reimbursement. The prior art also lacks such software that reimburses its cost to the user through the sales generated to a customer from within the same software application.

### SUMMARY OF THE INVENTION

While registering or modifying an account for a cloud-based software application that has a license with its cost, a user can select a reimbursement payment model to pay back the cost of the software application. The present invention pertains to a cloud-based software application where the user is paid for work, service, product, inventory, material, data, or any other exchange and accepts payments from a customer to the user of the software application. The same cloud-based software application has the capability to accept payments directly from customers. The software application user allows the software application to process sales payments through the same cloud-based software application to cover and reimburse the software application cost. The cloud-based software application provider gets paid through the software application user agreeing to allow the cloud-based software provider to automatically schedule the term billing cycle, such as monthly or otherwise, and collect the software cost from the sales generated with the software application. The entire amount of the sales generated with the software application are paid to the software application user less the subscription cost amount, per subscription term billing cycle, such as monthly or otherwise, and less bank or credit card fees associated with processing the payments from the customers through the software application payment function.

This software application does not employ the software application user by paying them a rate or a percentage per service. This invention provides the software application user a platform to receive leads, accept, manage paying jobs, sales, or other forms of a transaction, and a portion of the payment received will pay for the software application subscription. Per software application subscription term billing cycle, such as monthly or otherwise, the software application cost payment is authorized in full or until paid in full with one or multiple paying jobs, sales, or other forms of a transaction, then the software application user continues to receive all other funds less bank or credit card fees associated with processing the payment until the next payment is due.

For example, if the term billing cycle is monthly with a software application license payment due the first of the month, the software application user has an amount due at this time. The software application user receives payment of $1,000.00 for a service on the third day of the month, the software application automatically pays the software application user $1,000.00 for the service less the software application cost of, for example, $200.00 with a final deposit amount of $800.00 to the software application user less any bank or credit card transaction processing fees. Any additional service earnings, less any transaction processing fees, for the remainder of the month, will be paid to the software application user on the next billing cycle.

The method of this invention includes automatically, programmatically handling the payments to collect and disburse transaction balances to the software application user accordingly. In addition, this method of cloud computing reimbursement payment model includes the ability for the software application provider to construct a cost structure term to incentivize the software application user with a discounted software application license cost after an allotted amount of time has been met of continual, successful software application payments. The ability for the software application provider to create a payment term structure with an incentive includes any of the following: price increase or decrease, additional services, additional access, or other metrics.

For example, the software application user could receive a reduced software application license cost after six months of successful software application payments or receive added services, features, products, access, or other updates to the software application with no price change or add these services for an incremental price increase.

This invention automatically schedules, manages, and incentivizes retainment of recurring reimbursement payments to pay for the cost of a cloud-based software application license by deducting the payment, when due, per billing cycle, from received transactions, from within the same software application. This present invention does not pay the software application user as an employee or independent contractor from a percentage of the sales but is a reimbursement payment model of the software application costs—the software application user continues to function independently and receives all other earnings from the software application directly. The present invention does not view its user as an employee and not as an independent contractor.

The present invention collects the reimbursement of the software application costs only on a per term billing cycle, such as monthly or other time interval.

The present invention provides a method of applying for financing cloud-based software subscription costs during the registration process for the same cloud-based software. Cloud computing software companies provide a financing option of their own software product to increase engagement, conversion-to-sale, and retention of new and existing customers. This invention of financing a cloud software product, and including the financing application with the registration or upgrade of the cloud software product, provides more opportunity for more customers and cloud software providers to prove the efficiencies of their software. And, the customer can offset the software costs while onboarding the cloud software and the cloud software providers have a longer runway to provide the return on investment from their cloud software.

In an alternate embodiment, this invention utilizes automated processes with technology so that loan borrowers will receive prompt application approvals to proceed with the benefits of the software product as a seamless part of the cloud software product license registration.

In an alternate embodiment, the invention offers an option during cloud-based software product license registration, to apply for financing the cloud-based software subscription costs. Upon signing up for or upgrading the software, the loan borrower can choose to apply for and be granted a loan to spread out and lower the monthly software subscription cost. Upon loan approval, the loan will be funded to a newly created financial account where the cloud software company is allowed to deduct and pay for the monthly subscription payment.

This method of software creates a more integrated and streamlined way to allow a loan borrower to apply for and obtain financing for cloud-based software. The loan application process completes quickly by automatically, programmatically, utilizing affiliated financial, credit, and other applicable data sources. The loan application status is automatically communicated with the loan borrower of the software application where they can rapidly continue with the software usage benefits.

Upon loan approval, the present invention creates a new financial account to receive deposit of the loan funding. The present invention debits funds from this new financial account to pay for the cloud-based software product costs. Per a provided loan term schedule, the actual loan payment is charged to the loan borrower and is effectively their reduced cost for the cloud-based software.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and devices for carrying out the several purposes of the present invention. It is important, therefore, that the claims be regarded as including such equivalent constructions insofar as they do not depart from the spirit and the scope of the present invention.

It is therefore an object of the present invention to provide a new and improved method for cloud computing cost reimbursement payment.

Still another object of the present invention is to provide the process, application, and computer program to apply for financing for leased, cloud-based software on the sign up or upgrade of the said cloud-based service.

Still another object of the present invention is to provide users who are signing up for the cloud-based software application an option to request for a financing to pay for the said cloud-based software application. This sign-up process is modular, custom coded technology that can be added to web or software applications to gather necessary information from the loan requester.

Still another object of the present invention is to collect user data on the software application to submit a request for a loan. The software application is subject to request data input, document uploads, request loan documents, connect to, integrate, and electronically, automatically work with other financial technology, data sources, data queries, document reading, and any other read or write connectivity of internal or external data for the approval process. The approval process of this invention will programmatically, automatically perform the necessary steps to approve, deny, or state a need for additional information needed.

Still another object of the present invention is the software application will communicate electronically with the software application and loan requestor, with loan status updates.

Still another object of the present invention is this solves a problem with the affordability of software by providing a reduced subscription price for the user and is financially sustainable for the cloud software application provider because they will get paid from the loan funding. The software application license cost will be reduced within a loan term to allow a longer onboarding and setup time for the software subscriber.

Still another object of the present invention is upon loan approval, the loan is funded to a financial account and status update data is subject to be read or written back to various parties involved with the loan process where communication is necessary.

Still another object of the present invention is loan payments are made automatically to the lender with a debit transaction from the loan borrower's account saved within the software system.

Still another object of the present invention is loan terms are set by the software application subscription and licensing agreement, the lender, the subscriber to the software application, and any other necessary parties to complete the loan application and software application registration process.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

In referring to the drawings,

FIG. 1 is a flow chart describing the preferred embodiment of the present invention;

FIG. 2 is a flow chart further describing the preferred embodiment of the present invention the invention after FIG. 1; and

FIG. 3 is a flow chart further describing the preferred embodiment of the present invention continuing FIG. 2.

The same reference numerals refer to the same parts throughout the various figures.

### DESCRIPTION OF THE PREFERRED EMBODIMENT

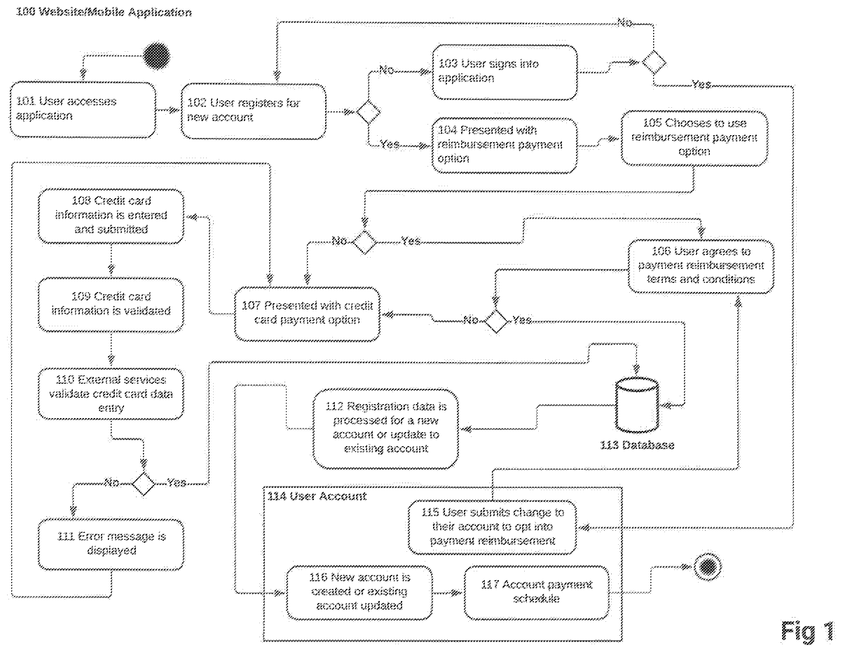

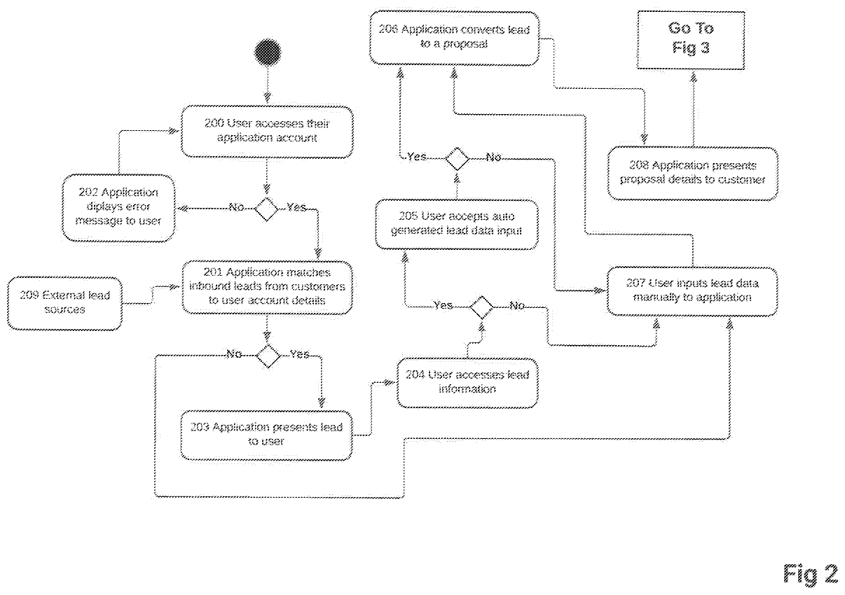

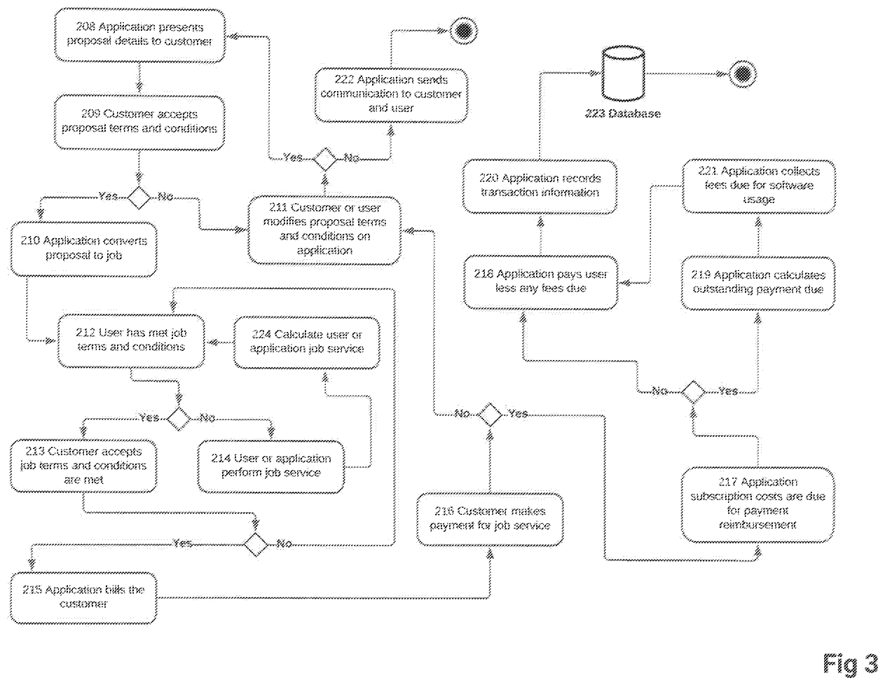

The drawings illustrate the invention, particular implementations of processes and methods of carrying out the invention, the Method For Cloud Computing Cost Reimbursement Payment. In brief, FIG. 1, as a flow chart, describes how a user of the invention's software application initially registers and is then presented with the option to, during this software application registration process, accept the terms and conditions and use the method of reimbursement payments to pay for the software application. FIG. 2, as a flow chart, then describes how the user of the software application signs into their existing account, uses the software application to receive external lead sources. And FIG. 3, also as a flow chart, then illustrates and describes the process of monetary transactions from customer payments and handling of these payments. The handling of the payment then reimburses the software application fees due, on their due date, from the software application user. The payment handling continues on to how the user is paid the remaining amount of the transaction or, when no software application fees are due, all of the payment made from the customer in this situation.

Turning to FIG. 1, here a user of the invention accesses it through a website or mobile application, on a mobile device, as at 100, and securely registers for a new account 101, or signs in 103 and updates 115 his existing account 114. The method of this invention transmits data to a database 113 for the software application to create a new cloud-based user account or update an existing account, collectively as at 114. During the software application new account registration process, as at 102, the invention presents to the user a reimbursement payment option 104 to choose, as at 105, or select, the invention, or the cloud computing cost reimbursement payment, to pay for the software application costs. When the user agrees to payment reimbursement terms and conditions, as at 106, the invention transmits this data input to the database 113 and processes, as at 112, the registration data for a new account, as at 114. Terms and conditions as used herein is one concept though it has three words. The user also has the option of submitting a change to their existing account 115 later to opt in for cloud computing reimbursement or credit card payment terms. Where credit card appears in this description, that phrase includes related financial activity including debit card, wire transfer, automated clearing house, and mobile payments, such as Venmo®, Zelle®, CashApp®, PayPal®, and others.

When the user chooses to apply for the invention, or cost reimbursement payment, to pay for the software application 105, the user securely agrees to the cost reimbursement terms and conditions, as at 106, and the software application proceeds to process the data and then transmits that data input to the database 113 once more. Then the user of the invention has access to an administration user account 114 or, if the user denies the user agreement as at 106, then the user is presented with a credit card payment option 107. There, the invention receives from the user his entered credit card information, as at 108, and the software application validates this entered credit card information 109 with external credit card services, as at 110. If the entered credit card input is successfully, the invention then transmits this data to the database 113. The invention then processes the registration data for a new account, or an existing account is updated, as at 112. Where the user account is created or existing account updated, as at 116, the user account 114 will now show application payment information and schedule where applicable, as at 117. If user credit card is not successfully validated, as at 110, then the software application displays an error message, as at 111, to the user and the invention presents to the user again the credit card entry option again 107.

With an account open and payment entered into the invention, FIG. 2 begins where the user navigates, or is directed to a website or an application on a mobile device for the invention 100 and securely accesses their application account. If successfully signed into the software application 200, the application matches inbound leads from customers to user account details, as at 201, where the invention the displays, or presents, to the user information as a lead 203 from external lead sources 209. As a reminder, the user operates the method of the invention, the user has its own customers who communicate to the user, and the customers have limited use of the invention primarily under user direction as later explained. The invention then allows the user to choose to access the lead information 204 and accept the lead from the auto generated lead input 205 to the software application. The application of the invention then converts the lead to a proposal 206 where the application presents the proposal details, terms, and condition with the customer 208. If the user accesses the lead information 204 and does not accept the auto generated lead data input 205, then the user may input lead data manually into the invention, or the application, as at 207, where the invention converts this manually entered lead information to a proposal as at 206, and then the invention presents the proposal details to the customer 208.

As a user operates the invention and a user sees information from it, FIG. 3 begins. The invention, or the application, presents proposal details to the customer, as at 208, and the customer accepts or does not accept the proposal terms and conditions 209. If the customer does not accept the proposal terms and conditions 209 then proposal details are modified upon the invention between the customer and the invention's user, as at 211, and if the customer or software application user do not modify the proposal 211 then the application sends communication to the customer and software application user.

If the customer accepts the proposal terms and condition, as at 209, then the software application converts the proposal to a job 210, or a project. The term project includes work performed by tradesmen, contractors, professional services firms, and the like, along with their results, and also physical items. If service hours, actions, or functions remain on the proposal term specifications, as at 212, then the software application user or the invention itself perform the service 214. The invention then calculates the value of the service completed as at 224 for billing purposes and to compare with the job's, or service's, terms and conditions.

If the software application user or the invention have met job terms and conditions 212, then the software application notifies the customer requesting acceptance of job terms and conditions 213. If the customer accepts the job terms and conditions 213 then the software application of the invention sends a bill to the customer 215 for the job and the customer makes the payment for the job, service, or transaction, as at 216, through the invention. Then the software application of the invention verifies if the software application subscription cost is due based on reimbursement payment terms and conditions and payment schedule as at 217. If so, the software application of the invention calculates the outstanding payment due 219 and the invention collects these fees due for the software application usage from the software application user, as at 221. The invention deducts this payment from the payment form authorized by the customer.

If the application subscription cost is not due as at 217, then the software application user has no fees deducted from this payment and receives a full payment authorized by the customer 218. Then, the software application of the invention records the transaction and service information automatically 220 to a database 223. If the customer does not make the payment for the job service, as at 216, then the customer or user modify the proposal terms and conditions on the invention through its software application embodiment, as at 211, where the invention the presents these modified terms and conditions to the customer as at 208, also initially described above. Here, the customer or user via the invention can accept or deny these modifications as at 209 until the customer and the software application user, user of the invention, come to terms to finish the job, service, or transaction.

In an alternate embodiment, the invention had a user of the software application who initially registers and is presented with the option to, during this software application registration process, accept the terms and conditions and use the method of reimbursement payments to pay for the software application. Then the user of the software application signs into their existing account, uses the software application to receive external lead sources to process monetary transactions from customer payments to the software application user.

In the alternate embodiment, a user navigates or is directed to a website or application on device and securely signs up or updates their existing account and data is transmitted to databases for the software application online using a device to create a cloud-based software application user account. During the software application account signup data input is transmitted to databases that process it, and the user is presented with the option to securely apply online for a cloud computing cost reimbursement payment model to pay for the software application costs.

When the user chooses to apply for the cost reimbursement payment model to pay for the software application, the user securely agrees to the cost reimbursement terms and conditions and the software application proceeds to process the user data and then data input is transmitted to databases or other data storage and the software application user now has access to administration account or, if the user denies the user agreement then the user can enter their credit card information and submit the credit card information and the software application validates with external credit card services, the credit card information and data input is transmitted to database processes. If the user credit card information is validated the user registration data is processed and software application presents user with secured administration account showing software application payment information and schedule. If a user's credit card is not successfully validated then the software application displays error message to the user and is presented with the credit card entry option again.

The alternate embodiment continues where the user navigates or is directed to a website or application on a device and securely signs into or accesses their application account, and, if successfully signed into the software application, the user is presented with information as a lead from external lead sources and the user chooses to access the lead information and accept the proposal from the lead input to the software application then proposal details and terms are communicated with the customer and the customer accepts the proposal and any or no affiliated proposal terms and if the customer does not accept the proposal and any or no affiliated proposal terms then proposal details are modified and any or no affiliated proposal terms with the customer. If service hours or actions are remaining on the proposal term specifications then the user and or application perform the service and are calculated for billing purposes then the software application bills accordingly for the service and the customer makes the payment for the job, service or functional transaction then the software application verifies if the application subscription cost is due and, if so, the user's allocated, current payment is due based on reimbursement payment terms and conditions and payment schedule, and is deducted from the payment authorized by the customer. If the application subscription cost is not due, then the user receives payment authorized by the customer less any or no affiliated service fees and, then, the software application records the transaction and service information automatically. The present invention operates upon a database.

During usage, the user of the method navigates or is directed to the method of the present invention stored upon the user's electronic device. The software application user registers for a new account or updates their existing account. While registering for a new account or updating an existing account, the software application displays an option to view additional information about reimbursement payments to pay for the software application. The software application presents the user with detail showing an example payment schedule with reimbursement method or the user bypasses this information. The software application user chooses to use the reimbursement option to pay for the software application.

The software application user agrees to or denies the reimbursement payment terms and conditions. If the software application user denies the reimbursement payment terms and conditions the user is presented with a credit card payment entry option to pay for the application. If the software application user accepts the reimbursement payment terms and conditions, the user account registration data is processed, and registration process is finalized. The software application presents the user with a secured administration account access showing application leads, payment information and schedule.

Once the software application user account has been created, the user signs into or accesses their application account. If the user has successfully signed into or accessed their account, the user is presented with information as a lead within the software application. If the user has not successfully signed into or accessed their application account they will receive a message and be redirected to sign in or access again.

Once signed in successfully to the software application, the user is presented with lead information. The user accesses lead detail information and accepts the lead offer per lead or service type or the user enters a new lead and service manually into the software application. Once the user accepts the lead offer, the lead converts to a proposal where details are communicated to the customer along with any or no affiliated terms and conditions.

The customer accepts the proposal and any or no affiliated terms and conditions. If the customer does not accept the proposal terms and conditions, the proposal and any or no affiliated terms and condition details are modified and are resubmitted back to the customer for approval. If the customer does not respond to the resubmitted proposal terms and conditions, the software application attempts to contact the customer until sending final communication.

When the customer accepts the proposal terms and conditions, the application begins to track whether or not the terms and conditions have been met with the current service. If the service terms and conditions have been met, the software application bills the customer. If the service terms and conditions have not been met, the software application continues tracking the service terms and conditions until met or until manually reconfigured.

The customer makes payment for the service per service terms and conditions and the software application verifies if the software application subscription cost is due from the software application user. If the software application cost is due, the allocated payment ratio, credit, incentive offer increase or reduction on cost or service offering is calculated and the amount outstanding is deducted from the payment authorized by the customer. The software application user receives payment authorized by the customer less any or no affiliated service fees and any or no transaction processing fees. If the customer does not make payment for the service when billed, a payment arrangement including details and any or no terms and conditions are communicated with the customer. The customer accepts the revised service payment arrangement and any or no affiliated terms and conditions, the application tracks whether or not the terms and conditions have been met with the current service, then re-bills the customer accordingly. If the customer does not accept the revised payment arrangement, additional service payment arrangements are made and either eventually accepted or not by the customer where the software application is paid for the service or is forced to close the service agreement and seek other methods outside of the scope of this software application. The software application of the invention records the translation information for any transactions accordingly.

In an alternate embodiment, a user securely signs up for the software online using a device, device screen, and device keyboard to create a cloud-based software user account. During the software account signup process, the user is presented with the option to securely apply online for a loan to finance the software cost.

When the user chooses to apply for financing of the software cost, the user securely inputs additional data and securely uploads files to the software interface and securely submits data to the software and software processes loan application request with internal software application processing and outside loan application data servers and data sources to automatically, programmatically complete the loan application process with the software and with any other sources which, any other sources for processing loan, send loan application detail data back to the software application. Once the software's loan application process completes the loan application process status is communicated to the user by email, SMS/text message, and back to the software user administration area. If the loan is approved, the loan is funded to a new read only financial account where software will debit this financial account for the software price. The user will have read-only access to the financial account. Software payment history will be displayed on software user account.

The user navigates to the cloud-based software application on a device. The user chooses to subscribe to the cloud-based software application and apply for a loan to finance the costs of the application. For the finance portion of the registration and lending process, the user inputs data and uploads documents specifically to apply for cloud-based software financing. The user verifies, approves, and certifies data accuracy before electronically submitting a loan application for processing to and as part of the invention. If the user is an existing customer of the cloud-based software, they are presented with the financing option to their existing account.

The invention receives the loan application request electronically and automatically sends the loan application for additional computational processing. The loan application is processed through various steps and is subject to include programmatically sending the loan application data to proprietary or outside sources of data processing, lookups, underwriting, and vetting for approving or denying the loan.

The loan application processing steps are tracked and are available to be displayed on the customer administration area of the cloud-based software application upon user secure sign in. These steps include, but are not limited to, loan submission to underwriting, whether or not the loan is conditionally approved, the loan is clear to close, loan closing, and loan funding.

The loan application process has been completed. When the loan has been approved, the funds are allocated to a newly created account where the cloud-based software company is allowed to debit the account for the monthly software application subscription amount per the terms of the loan.

The loan borrower loan payment schedule begins, and the loan payment is automatically deducted from their own financial institution account. Payment history and any other necessary payment details are available to be displayed to the loan borrower in the customer administration area of the cloud-based software application upon user secure sign in.

If denied, loan denial is conveyed to the loan borrower in the customer administration area of the software application upon user secure sign in. The loan borrower is provided with the option of prepaying the loan amount. The alternate embodiment of the invention will perform ongoing monitoring of loan payment history and processes with internal, proprietary software application data analytics to offer additional financial services to the user and cloud-based software company.

And, the present invention tracks a project performed by a customer and then disburses payment for the project to a user of the invention. On a database, possibly two of them, the invention registers its user and receives data from the user, then registers a customer of the user and receives data from the customer. With that data, the invention creates a project requested by the customer and generates terms and conditions for the project including an electronic payment schedule for it. The invention then presents the terms and conditions to the customer as described above and records the consent of the customer to those terms and conditions. Then the customer, and sometimes the user, works the project while the invention tracks the progress of the customer upon the project, The invention uses its tracking to determine completion of the project. When that has occurred, it calculates a payment upon completion of the project and processes authorization of the payment. The invention then collects a portion of the payment and sends it to the user, typically to cover a portion of the software license fee. The invention then disburses the remaining portion of the payment to the customer.

While a preferred embodiment of the Method for Cloud Computing Cost Reimbursement Payment has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Various aspects of the illustrative embodiments have been described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations have been set forth in order to provide a thorough understanding of the illustrative embodiments. However, it will be apparent to one skilled in the art that the present invention may be practiced without the specific details. In other instances, well known features are omitted or simplified in order not to obscure the illustrative embodiments.

Various operations have been described as multiple discrete operations, in a manner that is most helpful in understanding the present invention, however, the order of description should not be construed as to imply that these operations are necessarily order dependent. In particular, these operations need not be performed in the order of presentation.

Moreover, in the specification and the following claims, the terms “first,” “second,” “third” and the like—when they appear—are used merely as labels, and are not intended to impose numerical requirements on their objects.

The above description is intended to be illustrative, and not restrictive. For example, the above-described examples may be used in combination with each other. Other embodiments can be used, such as by one of ordinary skill in the art upon reviewing the above description. The Abstract is provided to allow the reader to ascertain the nature of the technical disclosure. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

I claim:

1. A method to allow a user to register for cloud-based software and to pay for the use of the cloud-based software, said cloud-based software being owned by software provider, said user having a customer, said method comprising:
registering a user;
receiving data from the user;
receiving a request to apply for cloud-based software application cost reimbursement from the user;
processing said request for cloud-based software cost reimbursement automatically and programmatically;
processing payments of a customer of the user;
generating customizable terms and conditions for an electronic payment schedule;
computing and processing authorization of a payment from payment funds of the customer;
including licensing incentive functions within said terms and conditions; and
presenting licensing incentive details to the user upon the user registering a new account and upon updating an existing account;
wherein said method reimburses a cloud-based software provider from the user's customer's payment accepted through said method;
wherein said method records agreement of the user to said terms and conditions generated by said method;
wherein said method records acceptance by the user of a structured incentive for payment reimbursement to the software provider during said registering a user or during said receiving data from a user.

2. The method to allow a user to register for cloud-based software and to pay for the use of the cloud-based software of claim 1 wherein said processing payments of a customer includes electronic payments of the customer.

3. The method to allow a user to register for cloud-based software and to pay for the use of the cloud-based software of claim 2 wherein said electronic payments includes credit card, debit card, wire transfer, automated clearing house, and mobile payments.

4. The method to allow a user to register for cloud-based software and to pay for the use of the cloud-based software of claim 1, further comprising:
providing at least one database wherein said method operates upon said at least one database.

5. A method of tracking a project performed by a customer and disbursing payment for the project to a user of said method, said method comprising:
registering a user of the method;
receiving data from the user;
registering a customer of said user;
receiving data from said customer;
creating a project requested by said customer;
generating terms and conditions for said project including an electronic payment schedule;
recording consent of said customer to said terms and conditions;
tracking progress of said customer upon said project;
determining completion of said project;
calculating a payment upon completion of said project and processing authorization of said payment;
collecting a portion of said payment and sending it to said user; and
disbursing a remainder of said payment to said customer.

6. The method of tracking a project performed by a customer and disbursing payment for the project to a user of said method of claim 5, further comprising:
providing within said electronic payment schedule means to move funds.

7. The method of tracking a project performed by a customer and disbursing payment for the project to a user of said method of claim 6 wherein said means to move funds includes credit card, debit card, wire transfer, automated clearing house, and mobile payments.

8. The method of tracking a project performed by a customer and disbursing payment for the project to a user of said method of claim 5, further comprising:
providing at least one database;
said registering a user of the method upon said at least one database;
said receiving data from the user entering that data upon said at least one database;
said registering a customer of said user upon said at least one database;
said receiving data from said customer entering that data upon said at least one database; and
said creating a project requested by said customer upon said at least one database.

9. The method of tracking a project performed by a customer and disbursing payment for the project to a user of said method of claim 8, further comprising:
said collecting a portion of said payment and sending it to said user is adapted to communicate with external credit card services; and
said disbursing a remainder of said payment to said customer is adapted to communicate with external credit card services.

10. A method of tracking a project performed by a customer and disbursing payment for the project to a user of said method, said method comprising:
registering a user of the method;
providing at least one database;
receiving data from the user;
registering a customer of said user;
receiving data from said customer;
creating a project requested by said customer;
generating terms and conditions for said project including an electronic payment schedule;
recording consent of said customer to said terms and conditions;
tracking progress of said customer upon said project;
determining completion of said project;
calculating a payment upon completion of said project and processing authorization of said payment;
collecting a portion of said payment and sending it to said user;
disbursing a remainder of said payment to said customer;
said registering a user of the method upon said at least one database;
said receiving data from the user entering that data upon said at least one database;
said registering a customer of said user upon said at least one database;
said receiving data from said customer entering that data upon said at least one database;
said creating a project requested by said customer upon said at least one database;
said collecting a portion of said payment and sending it to said user is adapted to communicate with external credit card services;
said disbursing a remainder of said payment to said customer is adapted to communicate with external credit card services;
including licensing incentive functions within said terms and conditions; and
presenting licensing incentive details to the user upon the user registering a new account and upon updating an existing account;
wherein said method reimburses a cloud-based software provider from the user's customer's payment accepted through said method;
wherein said method records agreement of the user to said terms and conditions generated by said method;
wherein said method records acceptance by the user of a structured incentive for payment reimbursement to the software provider during said registering a user or during said receiving data from a user.

11. The method of tracking a project performed by a customer and disbursing payment for the project to a user of said method of claim 1 further comprising:
providing within said electronic payment schedule credit card, debit card, wire transfer, automated clearing house, and mobile payments.
